(19) United States
(12) Patent Application Publication
(10) Pub. No.: US 2006/0029000 A1
(43) Pub. Date: Feb. 9, 2006

(54) Connection establishment in a proxy server environment

(75) Inventor: Marcel Waldvogel, Stein am Rhein (CH)

Correspondence Address: LOUIS PAUL HERZBERG, 3 CLOVERDALE LANE, MONSEY, NY, 10952, US

(73) Assignee: International Business Machines Corporation, Armonk, NY (US)

(21) Appl. No.: 11/127,617

(22) Filed: May 12, 2005

(30) Foreign Application Priority Data
May 14, 2004 (EP) 04011535.4

(51) Int. Cl. H04L 12/28

(52) U.S. Cl. 370/254

(57) ABSTRACT

A group of servers (GS) comprising a proxy server (PS) and one or more server computers (SCx). The group of servers (GS) is designed for supporting a mechanism for connection establishment which mechanism comprises an allocation of a predictable sequence number according to a given function shared between the group of servers (GS).

### FIELD OF THE INVENTION

The invention relates to a method for establishing a connection from a proxy server to a client, a method for operating a connection between a client and a server computer, a method for establishing a connection in a system comprising a group of servers, corresponding computer program elements, a proxy server, a server computer, and a system comprising a group of servers.

### BACKGROUND OF THE INVENTION

In today's networks, many devices perform Layer-5 (L5) switching, also known as Layer-7 switching. In L5 switching, the switching decision—such as whether to accept a connection and where to forward it to—can not be made from the network header/s of a single packet alone, but requires additional information. A typical information might be the URL (Uniform Resource Locator) of an HTTP request or other higher-order protocol information. This information is typically only available after the TCP (Transmission Control Protocol) connection has already been set up. This requires the L5 switch to terminate the connection, which makes it hard to later forward it to the ultimate destination. This forwarding process, known as TCP splicing, requires the L5 switch to first set up a new connection to the destination, and then perform connection state translation between the two connections on all future packets.

This translation requires per-connection state, notably the real destination address after splicing, and a TCP sequence number offset, which needs to be added to all outgoing sequence numbers and subtracted from all incoming acknowledgment numbers as the receipt of a particular sequence number is acknowledged. Touching these fields also requires classification of each packet to match it to its connection and updating of the TCP checksum header field.

Keeping a connection state table and performing the lookup can be very expensive, especially at high packet rates or when many connections need to be maintained. The problems are the amount of state to keep while exhausting the available fast memory quickly and the lookup time it takes to fetch the connection state which time typically grows as the amount of state information grows. For shorter state tables, often more efficient lookup mechanisms can be employed, to speed up the lookup further.

In many applications where L5 switching is employed, the destination address can be determined deterministically based solely on information contained in every packet basis, e.g., in firewalls, port forwarding applications, and some load balancers. In some cases, state for some exceptions needs to be kept, e.g., in firewalls, where a connection was refused and packets should thus not be passed on; or when a load balancer has decided based on the L5 connection headers that the destination should differ from the one the packet-header-only connection-agnostic algorithm would determine. These cases can be solved by storing the connection IDs, in case of TCP, a 5-tuple consisting of source and destination address and port numbers as well as the protocol employed, in a lookup table and only applied when a match is found. The only per-connection information left to maintain would be the TCP sequence number offset.

U.S. Pat. No. 5,774,660 illustrates a world-wide-web server with delayed resource-binding for resource-based load balancing on a distributed resource multi-node network. Layer-5 load balancing and traditional TCP connection splicing are introduced.

U.S. Pat. No. 5,815,516 shows a method and an apparatus for producing transmission control protocol checksums using Internet protocol fragmentation.

U.S. Pat. No. 6,006,259 provides a load balancing mechanism for a network clustering system for the “hot” handover of TCP connections when a machine in the cluster fails. TCP splicing is used.

U.S. Pat. No. 6,182,139 illustrates a client-side resource-based load-balancing with delayed-resource-binding using TCP state migration to a WWW server farm which performs handover of connections from a failed server to a fallback server.

U.S. Pat. No. 6,314,465 discusses wide-area load balancing. In U.S. Pat. No. 6,061,341 TCP packets are intercepted and retransmitted over a wireless/mobile link. U.S. Pat. No. 6,341,129 talks about TCP resegmentation, and U.S. Pat. No. 6,327,626 introduces an interception TCP connection setup to have one side send different sized packets and change their size in the middle of the network.

U.S. 20010042200A1 and correspondingly EP01154610A2 show a method and a system for defeating TCP Syn flooding attacks. Syncookies are generated.

“SYN cookies”, D. J. Bernstein, retrieved and accessed on the Internet http:// cr.yp.to/syncookies.html on Aug. 19, 2003, introduces the concept of syncookies in the context of preventing denial of service attacks.

### SUMMARY OF THE INVENTION

According to an aspect of the present invention, there is provided a method for establishing a connection from a proxy server to a client, comprising at the proxy server: allocating a predictable sequence number according to a given function which function is shared amongst a group of servers the proxy server belongs to, and attaching the sequence number to a proxy connect request to be sent to the client.

According to another aspect of the present invention, there is provided a method for operating a connection between a client and a server computer, comprising at the server computer: upon receipt of a client acknowledgment including an acknowledgment sequence number: verifying the acknowledgment sequence number by applying a given function for calculating a sequence number which function is shared amongst a group of servers the proxy server belongs to, in case the acknowledgment sequence number is confirmed in the verification step: computing a successive sequence number based on the acknowledgment sequence number, and attaching the successive sequence number to a response message to be sent to the client.

According to a further aspect of the present invention, there is provided a system comprising a group of servers, the group of servers comprising a proxy server and one or more server computers; the group of servers being designed for supporting a mechanism for connection establishment, the mechanism comprising an allocation of a predictable sequence number according to a given function shared between the group of servers.

### BRIEF DESCRIPTION OF THE DRAWINGS

The invention and its embodiments will be more fully appreciated by reference to the following detailed description of presently advantageous but nonetheless illustrative embodiments in accordance with the present invention when taken in conjunction with the accompanying drawings, in which:

FIG. 1 a diagram of a network topology comprising a system in accordance with the present invention,

FIG. 2 shows the format of a TCP header,

FIG. 3 shows a diagram illustrating a standard TCP connection setup and data transfer between a client and a server computer,

FIG. 4 shows a diagram illustrating a proxy TCP connection setup and data transfer in such environment making use of the TCP standard principles illustrated in connection with FIG. 3,

FIG. 5 a diagram illustrating an elaborated proxy TCP connection setup and data transfer in such environment making use of the TCP standard principles illustrated in connection with FIG. 3,

FIG. 6 shows a diagram illustrating a proxy TCP connection setup and data transfer in accordance with the present invention, and

FIG. 7 shows a block diagram illustrating a proxy sever in accordance with the present invention.

### DETAILED DESCRIPTION OF THE INVENTION

The present invention provides methods, systems and apparatus for establishing a connection from a proxy server to a client. An example of a method comprises at the proxy server: allocating a predictable sequence number according to a given function which function is shared amongst a group of servers the proxy server belongs to, and attaching the sequence number to a proxy connect request to be sent to the client.

The present invention also provides a method for operating a connection between a client and a server computer. An example of a method comprises at the server computer: upon receipt of a client acknowledgment including an acknowledgment sequence number: verifying the acknowledgment sequence number by applying a given function for calculating a sequence number which function is shared amongst a group of servers the proxy server belongs to, in case the acknowledgment sequence number is confirmed in the verification step: computing a successive sequence number based on the acknowledgment sequence number, and attaching the successive sequence number to a response message to be sent to the client.

The present invention also provides a system comprising a group of servers, the group of servers comprising a proxy server and one or more server computers; the group of servers being designed for supporting a mechanism for connection establishment, the mechanism comprising an allocation of a predictable sequence number according to a given function shared between the group of servers.

The basic scenario provides a system comprising a group of servers facing client requests received over a network. Typically, before or at least while handling client request on the application layer, an underlying connection in a transmission layer has to be established for serving the exchange of information in the application layer. There can be many different ways for establishing connections, however, most of the standard ones have in common the attaching of sequence numbers to the messages exchanged in order to allow the receiving party to follow up with the serial communication. In particular the generation of an initial sequence number used for initiating a particular connection results from a random process. However, according to the present invention, it is appreciated to generate a predictable sequence number, and in particular a predictable initial sequence number. The function which is preferably a mathematical function calculating a sequence number from a variety of input variables is known to all members of the group of servers and is applied from all the members of the group of servers. Thus, e.g. a connection to a client initiated from a proxy server of that group of servers can later on be handed over to another server computer of that group, since any other server computer of that group can reproduce the initial sequence number used by the proxy server by way of applying the same shared function with the same input variables. To minimize security exposure, the initial sequence number preferably is only predictable to machines within the same administrative domain and on mutual trust, such as employed in the group of servers, also referred to as server cluster. A preferred way to achieve this local predictability without allowing remote hosts to guess the initial sequence numbers is to use a cryptographic function operating using a key which is not available to outsiders.

With regard to the transmission layer, the invention thus allows a client to communicate to a server computer or vice versa via a proxy server without requiring the proxy server to translate sequence numbers between a proxy-client connection and a proxy-server connection. As a result, there is no need for a sequence number offset to be administrated and executed at the proxy. Also, the need for updating both a sequence and an acknowledgment field—based on traffic direction—is redundant. Further, no checksum has to be modified. This all results in a smaller memory footprint in the proxy server and a faster execution time for a given number of connections. It even can allow traffic from the server to the client which often constitutes the majority in web applications to be entirely routed around the proxy server.

The invention is not only applicable to the transmission control protocol TCP, but e.g. also to Stream Control Transport Protocol SCTP, or to other protocols that perform connection set-up handshakes, and generally to any transmission protocol. Particularly, the invention can be used for any system where it is useful that the initial connection establishment towards the client is done by an entity differing from the one that will perform the bulk of the data transmission.

The group of servers comprises at least two servers including the proxy server which proxy server is understood as a server computer being exposed to client's requests and primarily having the function of acting as a switch—this is the reason why the term proxy server is also referred to as switch. There is no particular need that the proxy server according to the present idea fulfills the requirements of serving a client's request directly without having another server computer involved if the proxy server is capable of doing so. However, such function of a proxy server is considered to be a advantageous feature of the proxy server.

In a advantageous embodiment, the multiple server computers form a server farm. In such embodiment, the server computers can be located at the same location but not necessarily have to. Server computers serving primarily different applications such as mail servers or web servers can be summarized in a server farm, or server computers serving primarily the same application can be summarized in a server farm.

A advantageous way of grouping server computers to a group of servers according to the present invention can be an approach where all servers shielded by the same proxy server plus the proxy server itself form the group of servers.

The predictable sequence number is preferable subject to connection identifiers. This statement is equivalent to connection identifiers being input to the function for computing the predictable sequence number. Such sequence number is understood in its broadest context: A sequence number is part of the protocol used, however, such sequence number can be used e.g. in messages such as for requesting a connection or in data transmission messages or in acknowledgment messages.

Connection identifiers refer to the connection to be established. When a connect request shall be transmitted from one server of the group of servers including the proxy server to a client including a sequence number computed according to the shared function, some connection identifiers may already be known e.g. from the previous client connect request which in turn has stimulated the server to issue the connect request provided a bi-directional transmission protocol is applied. From such a client connect request, the server already knows source address of the client, source port of the client, and of course the destination address and destination port. Addresses are typically IP addresses. In addition, the type of protocol may be derived from the client's connect request such that the following information each of which being a connection identifier may form a 5-tuple as input variable to the function: [Source IP address; Destination IP address; Source port; Destination port; Type of protocol].

Another advantageous input variable is time. With regard to computing a sequence number including time as an input variable and in particular when computing such a sequence number for verification purposes such as introduced in some parts of the present specification, a connection setup may be in progress while the time variable—or any other variable that can change—changes, appropriate measures need to be taken to identify the original value of this variable. E.g., all possible variants need to be tried or a proper indication needs to be included in the information to be echoed back by the client.

A further advantageous input variable is a secret key shared between the group of servers. Such key can be a secret value only known to the participants of that group of servers, or even can be a cryptographic key applied within the function.

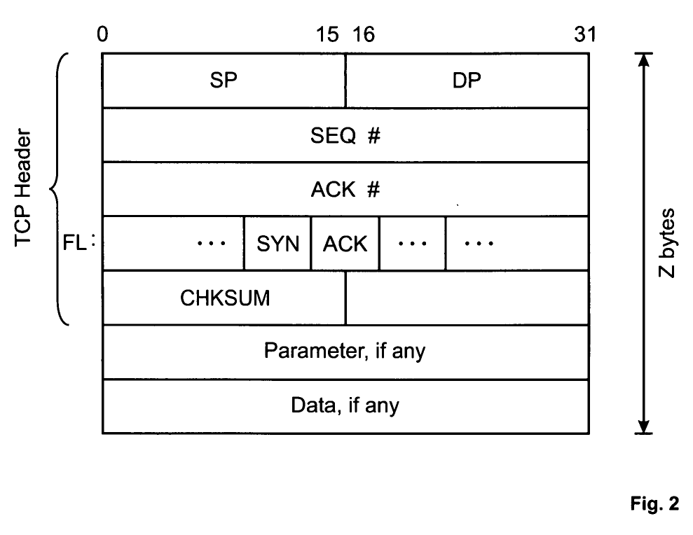

One or more connection parameters can further be used as input variable for calculating a sequence number. Such parameters can be parameters derived from a parameter/option field of the client connect request message, e.g. a TCP SYN message according to a format as shown in FIG. 2 and described more specifically e.g. in U.S. 20010042200A1 which is incorporated by reference.

According to a very advantageous embodiment, a sequence number is computed based on all the input variables mentioned above. Other embodiments might only use a selection of such input variables, a advantageous one uses the connection identifiers and the secret key.

According to the first aspect of the present invention, the proxy server causes to issue a connect request to a client including an initial sequence number computed according to the function being shared amongst the group servers. In case of applying a bi-directional transmission protocol such proxy connect request is preferably prepared and issued after a connect request from a client was received. The proxy connect request can be transmitted together with an acknowledgment of the received client connect request. In a advantageous embodiment having the TCP applied, upon receipt of a client SYN message at the proxy, a SYNACK message is transmitted from the proxy to the client including an acknowledgment sequence number for acknowledging the sequence number received in the client SYN message, and including a sequence number computed according to the function shared, this sequence number being associated to the proxy connect request SYN included in the combined SYNACK message.

Once a client acknowledgment is received at the proxy in response to such proxy connect request, such client acknowledgment is preferably forwarded to one or more server computers of the group of servers for further processing. Any consequence at such server will be discussed later on in connection with connection management at the server computer.

In case there is only one server computer connected to the proxy server or only one server computer besides the proxy server forming the group of servers, there is no need for the proxy server to make a selection where to direct the clients request to in case the proxy server does not handle the request itself. In case there are more server computers available in the group of servers, the proxy server preferably selects one or more of these server computers for taking over the clients request and for further processing. Any selection may be based on e.g. a resources a server computer can provide, or the content of the request, etc.

In particular, when the client's acknowledgment in response to the proxy connect request is forwarded—note that even this client acknowledgment packet may comprise data—all the following messages comprising data packets and identified as belonging to the established connection are preferably forwarded to the server computer without any mapping of proxy-client connections to server connections or vice versa as the server computer can handle such forwarded messages due to the sequence number being calculated by the function being joint to the group of servers.

With regard to the second aspect of the present invention, the behavior of a server computer of this group of servers is claimed upon receipt of a client acknowledgment comprising an acknowledgment sequence number. Since the server computer has not requested a connection to the client yet nor has the client with regard to the server computer the server computer is not aware of any connection at that point in time. However, due to using a joint function for generating sequence numbers within the group of servers there is typically no state of connections recorded at the server computers which stored state would inhibit the server computer from processing such a message that is not assignable to any state/open connection. As such function is applied, the server computer verifies whether the acknowledgment sequence number could possibly be a sequence number in response of an earlier connect request or another message sent from the server to the client. As the server computer does not keep record of such earlier communication, the server computer only checks whether the received acknowledgment sequence number could generally be a number valid for acknowledging a sequence number sent out previously by the server computer—or any other server of the group of servers as in fact did the proxy server. Thus, the server computer preferably computes the function e.g. with the available input variables: connection identifiers, secret key, parameters, and the actual time t in case the resolution of time t is big enough in relation to the round trip time for connection messages, and results in a computed sequence number. If the computed sequence number is equal to the received acknowledgment sequence number or otherwise associated (e.g. decremented by 1), the received acknowledgment number is deemed to be associated to a connection requested earlier in time from this sever computer or a another server of the group since all the members of the group compute sequence numbers based on this function.

In case the verification is positive, the connection will be maintained and e.g. a response message is sent from the server computer to the client, preferably including a subsequent sequence number in accordance with the protocol used, e.g. by applying increment, decrement or other functions. In case the verification proves not to be successful, the received message is preferably discarded.

According to other aspects of the present invention, there are provided a proxy server comprising a control unit designed for executing a method associated with a proxy server as claimed in claims 1 to 5, a server computer for executing a method associated with a server computer as claimed in any one of the claims 8 to 10, a system comprising such proxy server and/or at least one of such server computers.

Moreover, according to another aspect of the present invention there is claimed a method for establishing a connection in a system comprising a group of servers, the group of servers comprising a proxy server and one or more server computers, the method comprising at each member of the group of servers: supporting a mechanism for connection establishment, the mechanism comprising an allocation of a predictable sequence number according to a given function shared between the group of servers. According to a advantageous embodiment of this aspect of the present invention the method includes steps associated to the proxy server according to any one of claims 1 to 5, and/or steps associated to at least one server computer according to claims 8 to 10.

According to further aspects of the present invention there are provided computer program elements comprising code means for executing any method as claimed when loaded in a processing unit of a corresponding device.

Advantageous embodiments of the apparatus, the computer program elements and their embodiments go along with the advantages of the inventive methods respectively the inventive system and its embodiments as described above.

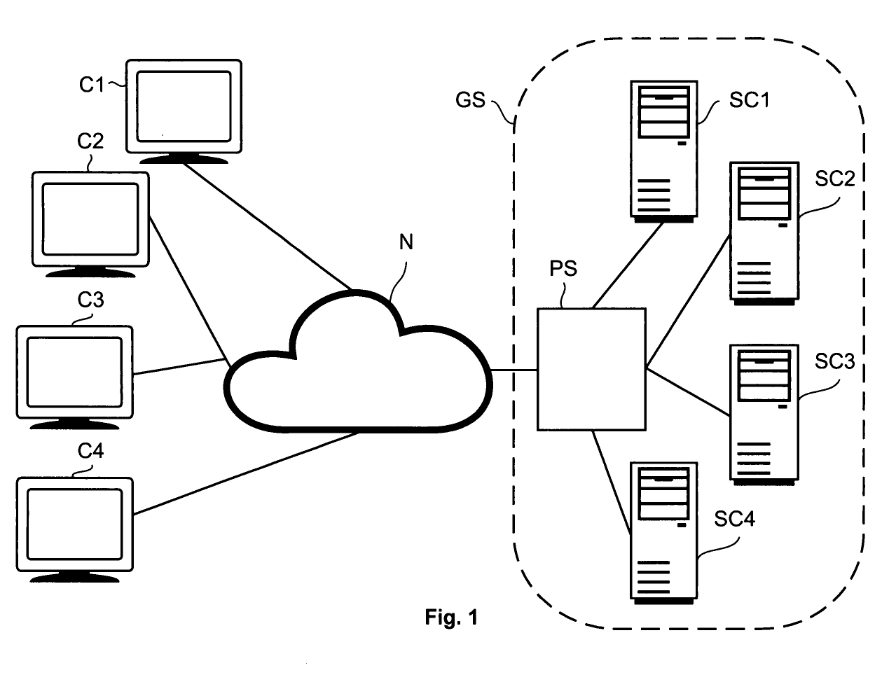

FIG. 1 illustrates a diagram of a network topology comprising a system in accordance with the present invention. A symbolic number of four client computers C1, C2, C3, C4 is connect via a network N, e.g. the Internet, to a system, the system comprising a group of servers GS. The group of servers GS comprises at least one proxy server PS and a symbolic number of individual server computers SC1, SC2, SC3, SC4. The proxy server PS—also referred to as load balancer or middlebox—typically intercepts all clients requests to the server computers SCx to see if it can fulfill the requests itself. If such a request cannot be fulfilled by the proxy server PS, the request is forwarded to at least one of the server computers SCx. A selection process might be established in the proxy server in order to select the server computer most suitable to answer the client's request.

For e.g. submitting a request from a client to a server in an application layer, a connection has to be established first in an underlying transport layer. A protocol suitable to set up such connection is the transmission control protocol (TCP). Typical tasks of the TCP are to form data packets suitable for transmission from the data delivered from the application, or to appropriate acknowledge received packets, etc., which tasks shall grant a reliable flow of data for the application layer above.

FIG. 2 symbolically illustrates the format of a TCP header used in TCP communication. The header typically follows the header used for the Internet Protocol, IP. Each row of the header includes 32 bits for storing information of a predetermined kind. The header is grouped into fields. In the TCP header sample according to FIG. 2, the first row includes a field containing information about the source port SP and another field containing information about the destination port DP of the subject application the transmission serves for. The ports generally identify the transmitting and the receiving application. The next field in the second row identifies a sequence number SEQ #. The sequence number SEQ # is a number providing control over the flow of consecutive TCP messages in one direction from sender to receiver. In case a new connection shall be established the first TCP message from the sender to the receiver comprises an initial sequence number SEQ #=ISN, which initial sequence number ISN is chosen randomly for preventing from manipulating a connection. Due to the format, an initial sequence number INS=SEQ # can be chosen by the sender from any number between 0 and 2ˆ{32}−1. Other fields comprise flags FL. For illustration purposes, only two flags SYN and ACK are shown, however a bigger number of flags FL can be included. A flag FL typically is set or is not set. The SYN flag is set by a sender whenever a new connection shall be established. As explained above, in such case the sender also provides a randomly chosen initial sequence number in the SEQ # field. After a connection is established the sequence number SEQ # identifies the number of bytes of data sent which number is related to the initial sequence number SEQ #.

Every byte exchanged is acknowledged by the receiver by setting the ACK flag in an acknowledgment message upon receipt of a message with a certain sequence number from the sender. The field acknowledgment number ACK # comprises the received sequence number SEQ #+1 for confirming the receipt of a message including sequence number SEQ #, which ACK # is the next sequence number the sender of the acknowledgment expects to receive. A packet header with a SYN flag counts as a data byte for the purpose of sequence/acknowledgment numbering.

A checksum field is filled with a checksum over the TCP header and TCP data, if any. Parameters—also referred to as options—can be added, as well as data. Source and destination IP addresses are not part of the TCP header but are included in the IP datagram which the TCP datagram including TCP header and TCP options and or TCP data forms part of.

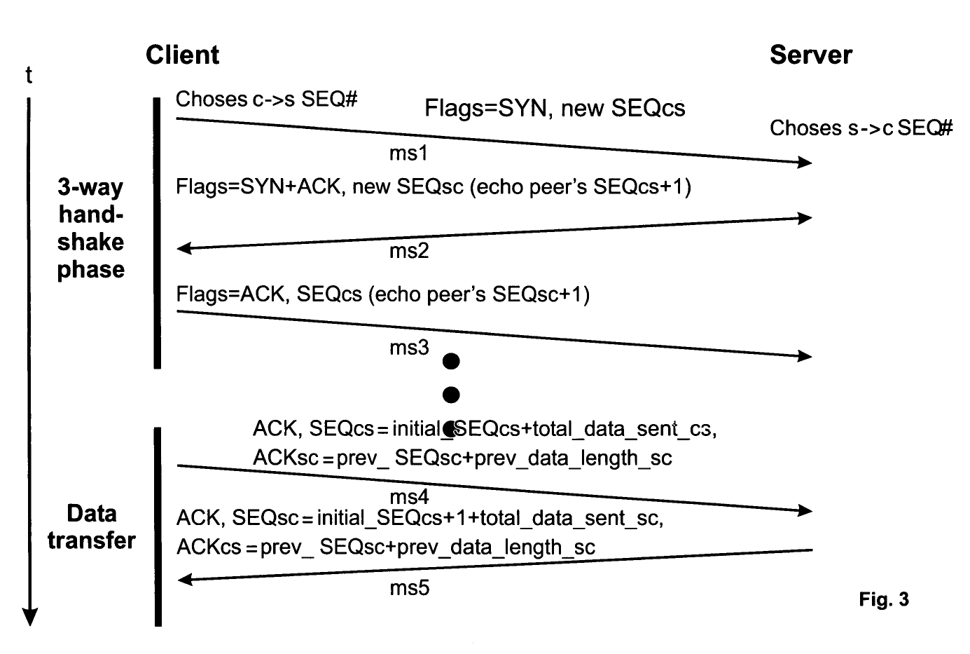

FIG. 3 illustrates a standard TCP connection setup and TCP data transfer between a client and a server computer as known from prior art. In particular, in the upper half of the diagram a connection establishment is introduced, this connection establishment is also referred to as three-way handshake phase, while the lower half of FIG. 3 illustrates a phase of data transfer. The individual messages msx are transmitted serially on a time scale t.

Provided a client computer requests a web page from a web server, prior to executing this request, a TCP connection has to be established between the client and the server. The following description is slightly simplified to draw attention to the important points. For exact operation of TCP, see e.g. “TCP Illustrated”, Volumes 1 and 2, W. Richard Stevens, Addison-Wesly, 18th printing, October 2000. The client sends message ms1 to the server. Prior to sending the message ms1 an initial sequence number SEQ # is randomly chosen by the client for establishing the client-server=cs connection. This initial sequence number—also referred to as new sequence number new SEQcs is filled in the SEQ # field according to FIG. 2 of a TCP packet together with a turned on SYN flag for identifying this message ms1 as a connect request. Having received message ms1, the server itself chooses a sequence number SEQ # for opening another connection between the server and the client—indicated by sc. As the TCP provides a full duplex connection service to the application layer, data can be exchanged between a client and a server in both directions. Thus, both parties which are named client and server in this example have to maintain sequence numbers for communication in the respective direction.

For this reason, the server sends a message ms2 to the client in which message ms2 the ACK flag is set for indicating that the server is acknowledging a clients' message together with an acknowledge number ACKsc # which is SEQsc+1 according to the TCP protocol. However, the server also opens a connection to the client, thus, simultaneously setting the SYN flag in message ms2 and providing the server-client sc sequence number SEQsc as an initial sequence number to the sequence number SEQ # field.

This message in turn has to be acknowledged by the client by transmitting message ms3 to the server. The ACK flag is set, the acknowledgment number ACK # is the server-client SEQsc+1, while message ms3 also provides the next sequence number SEQcs+1 for the client-server connection according to the TCP protocol. Note that a notation such as client-server connection should read as “client to server” connection and thus indication a direction of connection here.

For the reason that three messages are needed to establish a full duplex or bi-directional connection, this exchange of messages SYN, SYNACK, and ACK is also called three-way handshake. The term connection thus typically indicates a particular unidirectional connection regardless whether this unidirectional connection is part of a bi-directional direction. However, when talking of a bi-directional connection in a very broad sense, the term connection can also cover the bi-directional direction as such and thus comprise both of the unidirectional connections. The person skilled in the art will handle this term accordingly.

The data transfer phase as indicated in FIG. 3 in direction from the client to the server comprises in message ms4 the ACK flag turned on for acknowledging what was previously received from the server and setting the acknowledgment number for acknowledging the server-client connection by ACKsc=prev_SEQsc+prev_data_lenght_sc where prev_SEQsc is the sequence number SEQ # used previously in the server-client connection and prev_data-lenghL_sc denotes the number of data bytes received previously in the server-client connection from the server wherein the previous state is that state the client acknowledged for the last time any server to client data transmission. The sequence number SEQ # for the client-server connection is set with SEQcs=initial_SEQcs+1+total_data_sent_cs. While initial_SEQcs denotes the initial sequence number INS which is chosen when opening the client-server connection which is the new sequence number new SEQcs in message ms1 in case ms4 is part of the connection between client and server established in ms1 and the following messages. Starting from this initial sequence number, the number of data bytes sent from the client to the server in total total_data_sent_cs are added, as well as an increment 1.

Message ms5 of data transfer phase denotes a response on message ms4. Now, server sets the acknowledgment flag ACK for acknowledging message ms4 and provides acknowledgment number ACKcs=prev_SEQsc+prev_data_length_cs. Prev_SEQsc is the sequence number SEQ # used previously in the client-server connection and prev_data-lenght_sc denotes the number of data bytes received previously in the client-server connection from the server wherein the previous state is that state the server acknowledged for the last time any client to server data transmission. The sequence number SEQ # for the server-client connection is set with SEQsc=initial_SEQsc+1+total_data_sent_cs. While initial_SEQsc denotes the initial sequence number INS which is chosen when opening the server-client connection which is the new sequence number new SEQsc in message ms2 in case ms5 is part of the connection between client and server established in ms2 and the following messages. Starting from this initial sequence number, the number of data bytes sent from the server to the client in total total_data_sent_sc are added, as well as incremented by 1.

Generally, it is noted that on receipt of a message with SEQ # at any of client or server, this party acknowledges with a reply message including SEQ #+data_lenght in the acknowledgment number ACK # field. However, there is a convention that a set SYN bit is considered to be one byte of data.

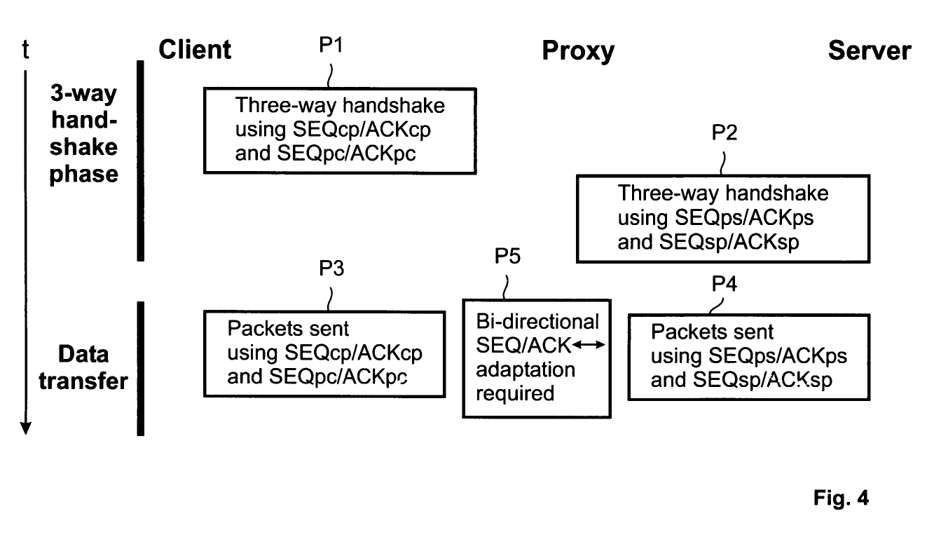

FIG. 4 illustrates a proxy TCP connection setup and data transfer in such environment making use of the TCP standard principles illustrated in connection with FIG. 3. Although a client might wish to approach a particular server and establish a connection with this server, server group architectures might comprise a proxy server including the features as explained above. As the proxy server primarily acts for a group of server computers, in a first procedure p1 a connection between the client and the proxy server—in short proxy—is established by way of three-way handshake using sequence numbers SEQcp and SEQpc, and acknowledgment numbers ACKcp and ACKpc respectively for performing this three-way handshake between the client and the proxy. In this notation cp stands for the client-proxy connection, and pc stands for the proxy-client connection. After having established the bi-directional connection between the proxy and the client, the proxy might detect no need to approach one or more of the server computer it is acting for, e.g. whenever the proxy server itself can serve the client's request. However, whenever there is a need to approach one or more server computers of the server group the proxy server is acting for, a connection to this or these server computers has to be established. Provided a particular server computer—in short server—is selected, in a second procedure p2 following the first procedure p1 on the time scale t a connection is established between the proxy and the server. New sequence numbers SEQ # randomly chosen by the participating parties are introduced to each other, and a three-way handshake is established between the proxy and the server. Sequence numbers SEQps and SEQsp and acknowledgment numbers ACKsp and ACKps respectively are used for performing this three-way handshake between the proxy and the server. In this notation ps stands for the proxy-server connection, and sp stands for the server-proxy connection.

For Layer-5 connection switching the proxy would itself participate in the exchange of the first few data packets until enough information was known to switch the connection to the server. These packets would then be replayed after the three-way handshake with the server after going through the SEQ/ACK adaptation as if the packets had only just received by the proxy. However, as indicated in FIG. 4 in connection with the data transfer phase, whenever data packets are sent between the client and the server via the proxy, be it in direction to the server or in direction to the client as indicated in processes p3 and p4, an intermediary adaptation process p5 is required at the proxy as the sequence and acknowledgment numbers used between the client and the proxy are different to the sequence and acknowledgment numbers between the proxy and the server, as any initial sequence number is chosen randomly by the initiating party. Thus, a sequence number SEQ # and acknowledgment number ACK # adaptation requires addition or subtraction—depending on packet direction—of an offset in numbers computed from the difference between the initial SEQcp/SEQps and SEQsp/SEQpc pairs. This in turn requires adaptation of the TCP checksum and potentially Layer-2 cyclic redundancy checks (CRCs).

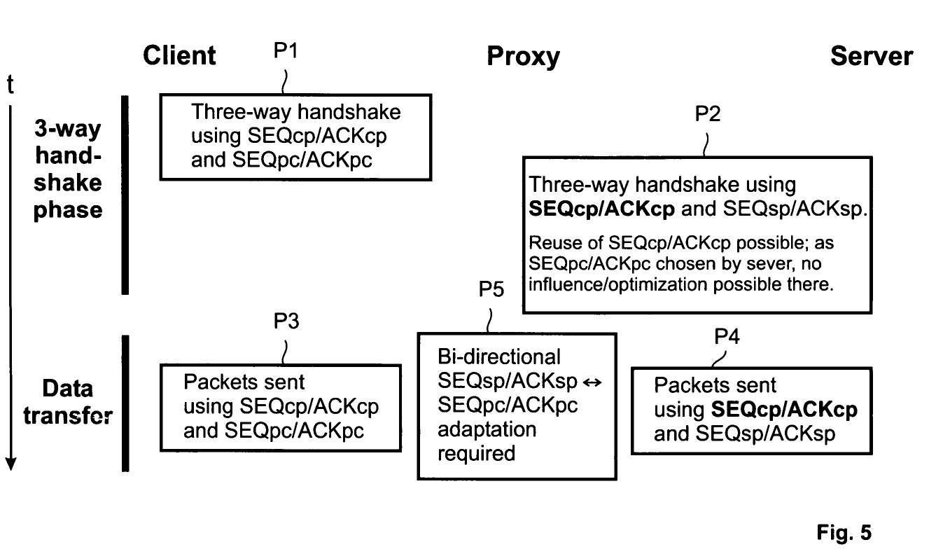

FIG. 5 shows a diagram illustrating an elaborated proxy TCP connection setup and data transfer in such environment making use of the TCP standard principles illustrated in connection with FIG. 3. While the first three-way handshake between the client and the proxy in process p1 is identical to the one of FIG. 4, process p2 for establishing a connection between the proxy and the server is now more elaborated than the three-way handshake between the proxy and the server according to FIG. 4. Instead of the proxy using a randomly chosen initial sequence number SEQps for the proxy to server path, it is now preferred to take as sequence number SEQps the initial sequence number SEQcp instead which initial sequence number SEQcp is known to the proxy from the three-way handshake between the proxy and the client. Accordingly, the acknowledgment number ACKsp from server to proxy is consequently based on the SEQps=SEQcp.

However, as the initial sequence number for the server to proxy connection is chosen by the sever, the proxy has no chance to influence or optimize there for lack of intervention.

With regard the data transfer phase it can be derived from FIG. 5, that whenever data packets are sent between the client and the server via the proxy, be it in direction to the server or in direction to the client as indicated in processes p3 and p4, an intermediary adaptation process p5 is still required at the proxy as the sequence and acknowledgment numbers used between the client and the proxy are different to the sequence and acknowledgment numbers between the proxy and the server with regard to particular packets: While an adaptation of sequence numbers SEQcs # from client to server and acknowledgment numbers ACKsc # from server to client can be avoided as the SEQcs #=SEQcp #=SEQps # and ACKsc #=ACKsp #=ACKpc # numbers are chosen by the proxy, which can use the results from the previous client-proxy handshake, there is still required an adaptation of one field in each packet through the proxy—either the sequence number SEQ # or the acknowledgment number ACK #, depending on the direction—as e.g. the SEQsp has to be translated in the proxy into the corresponding SEQpc and the ACKcp has to be translated in the proxy into the corresponding ACKps. This means that for correctness of the protocol, all packets need to be inspected and their associated flow determined, requiring the maintenance of a lookup table for recording the states of different flows, the offset retrieval, the application of the offset, and cheksum/CRC corrections as explained in more detail with regard to FIG. 4 still apply.

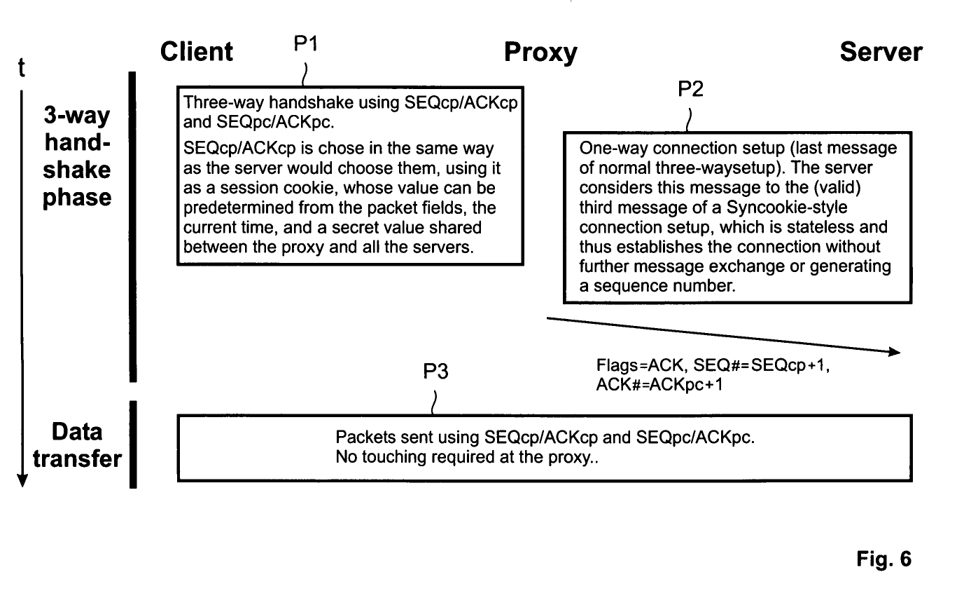

FIG. 6 is a diagram illustrating a proxy TCP connection setup and data transfer in accordance with the present invention. Process p1 denotes a bi-directional three-way handshake between the proxy and the client. However, while the client still uses a proprietary client-proxy initial sequence number SEQcp which is typically selected on a random basis and the proxy acknowledges with a sequence number ACK cp, the allocation of the initial sequence number for initiating a connection from the proxy to the client now follows a function known and used by all the servers of the group. Thus, the initial sequence number SEQpc is chosen by the proxy in the same way as any other server of the server group would choose it which number is based on at least information derived from packet fields such as destination and source address and a secret key/value shared between the proxy and all the servers.

Summarizing, when a connect request is received by the L5 switch/proxy, it locally generates the same reply sequence number the server computer would generate due to applying an agreed function. The L5 switch then continues with connection establishment and initial data gathering —e.g., reading HTTP request headers—as ordinary.

When the protocol applied here is the TCP protocol, it is noted that unlike in normal TCP connections and thus TCP splicing where it is not known which reply sequence number will be generated by the peer, the knowledge of the function and all the input variables—e.g. the secret key—allows the source which is in this case, the L5 switch—to know which sequence number would be created.

When the connection target has been identified by the proxy such as is the server according to FIG. 6, a one-way connection setup is established between the proxy and such server in process p2. This includes that the last message of normal three-way setup between the proxy and the client which is the client acknowledgment is forwarded to the server of the server group also indicated by the arrow between the proxy and the server and the associated flag and field information. The server itself considers this message to be the valid third message of a connection setup which is stateless and thus establishes the connection without further message exchange or generating a sequence number.

Additionally, all the data packets received so far from the originator are sent forward to the server unmodified, or, if desired, after appropriate modifications, as indicated in process p3 All future packets in both directions will also be forwarded unmodified. There is no need to prevent some acknowledgments of being returned, as they will be safely ignored by the originator—identified as duplicate packets. Even the connection establishment packets could be sent to the destination. Packets from the three-way handshake could also be transmitted; especially this relates to the SYNACK packet from server to proxy, which could also be sent to the client instead, especially if the return packets do not go through the proxy. They all would cause no harm and just be considered duplicates. Neither they nor the resulting acknowledgments will cause any harm and instead will be thrown away as duplicates by the originator. If the requirement for nonstandard forwarding was identified during the connection establishment, the appropriate forwarding state is established before forwarding any data. The state kept will be smaller as there is no need for sequence number offset, unless some of the servers behind the L5 switch are not capable of supporting the type of connection establishment according to the invention and thus require the full L5 splicing.

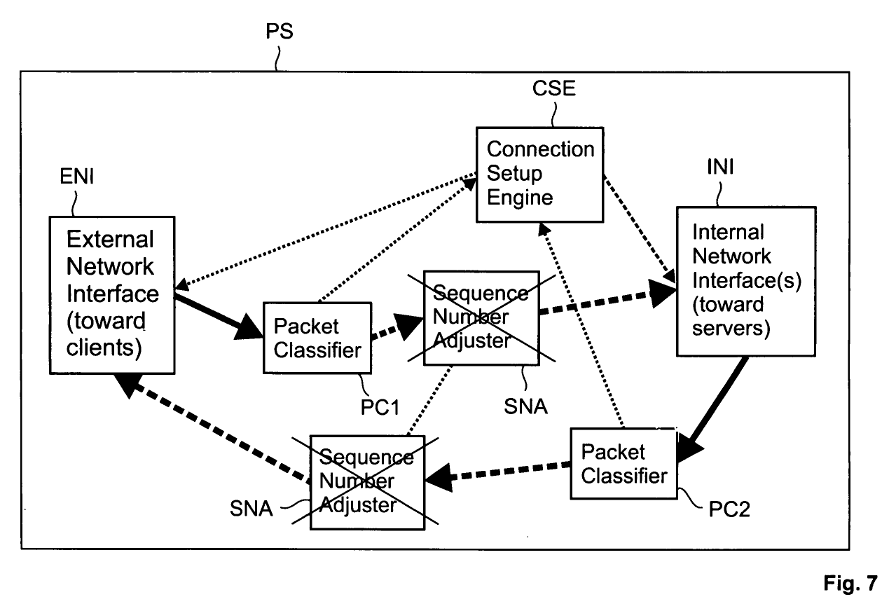

FIG. 7 shows a block diagram illustrating a proxy sever PS in accordance with the present invention. The proxy server PS comprises an external network interface ENI for receiving and sending messages to and from clients, an internal network interface for sending and receiving messages to and from server computers, a first packet classifier PC1—e.g. comprising a stack for caching messages before handling the messages received via the external network interface ENI according to instructions from a control unit CSE, a second packet classifier PC2—e.g. comprising a stack for caching messages before handling the messages received via the external network interface ENI according to instructions from a control unit CSE, and the control unit CSE.

Sequence number adjusters SNA in both of the paths towards the external network interface ENI and the internal network interface INI. for adjusting sequence and acknowledgment numbers in data packets according to instructions of the control unit CSE as required in prior art applications are not needed any longer in the proxy server and thus crossed out in FIG. 7, thus any number adaptation routines provided in the control unit becoming redundant. Bold dotted arrows in this block diagram indicate bulk data flow, thin dotted arrows connection setup data flow, and bold straight arrows common data flow.

The control unit CSE can be implemented in hardware or in software or in any combination of both.

The invention can be used for any system where it is useful that the initial connection establishment is done by an entity differing from the one that will perform the bulk of the data transmission, in particular when using one of TCP and SCTP.

In a preferred embodiment, the mechanism described can be implemented using TCP syncookies for computing predictable sequence numbers, which many operating systems support, in order to eliminate the need for a sequence number offset. Syncookies are introduced in U.S. 20010042200A1 which is incorporated herewith with regard to syncookies. The function for all machines behind the L5 switch may be set up to use TCP syncookies in the same fashion and with the same secret key which secret key used e.g. can be read and modified by user space programs with administrator privilege. To ensure a shared secret key, it can either be stored into a file on the proxy server or a small network server could be used which would only respond to requests from the server farm. The function and the secret key are also known to the L5 switch. However, any other mechanism besides TCP syncookies that would result in a predictable sequence number and could be easily deployed to the servers would also be applicable.

While the invention has been described with reference to exemplary embodiments, it will be understood by those skilled in the art that various changes may be made and equivalents may be substituted for elements thereof without departing from the scope of the invention. Variations described for the present invention can be realized in any combination desirable for each particular application. Thus particular limitations, and/or embodiment enhancements described herein, which may have particular advantages to a particular application need not be used for all applications. Also, not all limitations need be implemented in methods, systems and/or apparatus including one or more concepts of the present invention.

The present invention can be realized in hardware, software, or a combination of hardware and software. A visualization tool according to the present invention can be realized in a centralized fashion in one computer system, or in a distributed fashion where different elements are spread across several interconnected computer systems. Any kind of computer system—or other apparatus adapted for carrying out the methods and/or functions described herein—is suitable. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods.

Computer program means or computer program in the present context include any expression, in any language, code or notation, of a set of instructions intended to cause a system having an information processing capability to perform a particular function either directly or after conversion to another language, code or notation, and/or reproduction in a different material form.

Thus the invention includes an article of manufacture which comprises a computer usable medium having computer readable program code means embodied therein for causing a function described above. The computer readable program code means in the article of manufacture comprises computer readable program code means for causing a computer to effect the steps of a method of this invention. Similarly, the present invention may be implemented as a computer program product comprising a computer usable medium having computer readable program code means embodied therein for causing a a function described above. The computer readable program code means in the computer program product comprising computer readable program code means for causing a computer to effect one or more functions of this invention. Furthermore, the present invention may be implemented as a program storage device readable by machine, tangibly embodying a program of instructions executable by the machine to perform method steps for causing one or more functions of this invention.

It is noted that the foregoing has outlined some of the more pertinent objects and embodiments of the present invention. This invention may be used for many applications. Thus, although the description is made for particular arrangements and methods, the intent and concept of the invention is suitable and applicable to other arrangements and applications. It will be clear to those skilled in the art that modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art.

What is claimed, is:

1. A method for establishing a connection from a proxy server to a client, comprising:
at said proxy server allocating a predictable sequence number according to a given function which function is shared amongst a group of servers said proxy server belongs to, and
attaching said sequence number to a proxy connect request to be sent to said client.

2. A method according to claim 1, further comprising establishing said connection upon receipt of a client connect request.

3. A method according to claim 1, further comprising forwarding a client acknowledgment received in response to said proxy connect request to a server computer belonging to said group of servers.

4. A method according to claim 3, further comprising prior to forwarding said client acknowledgment to said server computer, selecting said server computer out of said group of servers for directing a client's application request to.

5. A method according to claim 1, further comprising forwarding data packets received from said client to said server computer.

6. A proxy server, comprising a control unit designed for executing a method as claimed in claim 1.

7. A computer program element comprising code means for executing a method according to claim 1, when loaded into a processing unit of a proxy server.

8. A method for operating a connection between a client and a server computer, comprising at the server computer upon receipt of a client acknowledgment having an acknowledgment sequence number:
verifying said acknowledgment sequence number by applying a given function for calculating a sequence number for a function shared amongst a group of servers to which the proxy server belongs; and
sending a response message to said client, when said acknowledgment sequence number is confirmed in said step of verifying.

9. A method according to claim 8, further comprising discarding said client acknowledgment when said client acknowledgment sequence number is not confirmed in said verification step and/or when an error message is returned.

10. A method according to claim 8, the step of verifying comprising:
calculating said sequence number based on data derived from the client acknowledgment and based on data shared amongst said group of servers,
comparing said calculated sequence number to said received acknowledgment sequence number, and
confirming said client acknowledgment sequence number, if said client acknowledgment sequence number is equal or otherwise associated to the calculated sequence number.

11. A server computer, comprising a control unit designed for executing a method as claimed in claim 8.

12. A computer program element comprising code means for executing a method according to claim 8, when loaded into a processing unit of a server computer.

13. A system comprising:
a group of servers,
said group of servers comprising a proxy server and one or more server computers, said group of servers being designed for supporting a mechanism for connection establishment, and said mechanism comprising an allocation of a predictable sequence number according to a given function shared between said group of servers.

14. A system according to claim 13, wherein said predictable sequence number is subject to connection identifiers.

15. A system according to claim 13, wherein said predictable sequence number is subject to a time parameter.

16. A system according to claim 13, wherein said predictable sequence number is subject to a secret key shared between said group of servers.

17. A system according to claim 13, in which said predictable sequence number is subject to one or more connection parameters.

18. A system according to claim 13, wherein said one or more server computers form a server farm.

19. A system according to claim 13, further comprising:
a proxy server comprising a control unit designed for executing a method for establishing a connection from a proxy server to a client; and
at least one server computer comprising a control unit designed for executing a method for operating a connection between a client and said at least one server computer.

20. A method for establishing a connection in a system comprising a group of servers, said group of servers comprising a proxy server and one or more server computers, said method comprising at each member of said group of servers a step of supporting a mechanism for connection establishment, said mechanism comprising an allocation of a predictable sequence number according to a given function shared between said group of servers.

21. A method according to claim 20, further comprising:
at said proxy server allocating a predictable sequence number according to a given function which function is shared amongst a group of servers to which said proxy server belongs;
attaching said sequence number to a proxy connect request to be sent to said client;
operating a connection between a client and at said at least one server computer, the step of operating comprising at the server computer:
receiving a client acknowledgment having an acknowledgment sequence number:
verifying said acknowledgment sequence number by applying a given function for calculating a sequence number for a function shared amongst a group of servers to which the proxy server belongs; and
sending a response message to said client, when said acknowledgment sequence number is confirmed in said step of verifying.

22. An article of manufacture comprising a computer usable medium having computer readable program code means embodied therein for causing establishment of a connection from a proxy server to a client, the computer readable program code means in said article of manufacture comprising computer readable program code means for causing a computer to effect the steps of claim 1.

23. A program storage device readable by machine, tangibly embodying a program of instructions executable by the machine to perform method steps for operating a connection between a client and a server computer, said method steps comprising the steps of claim 8.

24. A computer program product comprising a computer usable medium having computer readable program code means embodied therein for causing server functions, the computer readable program code means in said computer program product comprising computer readable program code means for causing a computer to effect the functions of claim 13.
